(19) United States
(12) Patent Application Publication
(10) Pub. No.: US 2009/0031901 A1
(43) Pub. Date: Feb. 5, 2009

(54) METHOD AND DEVICE FOR DELIVERING FOODSTUFF

(75) Inventors: Ray Peden, Everett, WA (US); Roman Probst, Seattle, WA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: NIRO-PLAN AG, Aarburg (CH)

(21) Appl. No.: 12/184,440

(22) Filed: Aug. 1, 2008

(30) Foreign Application Priority Data
Aug. 3, 2007 (DE) 10 2007 036 816.1

(51) Int. Cl. A47J 31/40; B67D 5/08

(52) U.S. Cl. 99/280; 222/64; 222/1

(57) ABSTRACT

A device and to a method for delivering drinkable liquid, in particular, milk or syrup, is provided wherein the device includes at least one pump, which can be connected to at least one container for drinkable liquid, so that, using the pump, the drinkable liquid can be delivered from the container. The device includes at least one sensor for measuring the fill level of the container, and the pumping process is stopped as a function of a measurement signal from the sensor when the measurement signal falls below or exceeds a given measurement signal limit. The sensor is constructed as a pressure sensor and the pressure sensor is arranged such that the pressure in the container for drinkable liquid can be measured by the pressure sensor.

### CROSS-REFERENCE TO RELATED APPLICATIONS

This application claims the benefit of DE 10 2007 036 816.1, filed Aug. 3, 2007, which is incorporated herein by reference as if fully set forth.

### BACKGROUND

The invention relates to a device and a method for delivering drinkable liquid.

In such devices, a drinkable liquid is delivered from a container by means of a pump. Simultaneously, by means of a sensor, the level of the container is monitored, so that for an empty container or at least when the level falls below a low level, the pump process can be stopped.

A typical field of application for such devices is coffee machines, in which, in addition to the coffee produced by a brewing unit, other drinkable liquid is also to be discharged into a cup, such as, for example, milk and/or syrup. Such coffee machines typically have a cooling unit, in which, e.g., a milk container is stored. When needed, milk is pumped out of the milk container, wherein the pump process is stopped when the container is empty, so that the pump does not “run dry,” that is, it is not operated without delivering liquid.

Here, it is known to monitor the level of the container by use of a capacitive resistor arranged on the container. If there is no more drinkable liquid in the container, then the resistance value of the capacitive resistor changes, so that the pump process can be stopped as a function of the measurement signals of the resistor.

Problems in such devices are that the functionality of the level monitoring is dependent on the arrangement between the capacitive resistor and the container and that, in addition, the measurement is inexact, so that frequently the pump process is stopped even though a considerable amount of drinkable liquid is still in the container. In addition, the control and monitoring of the capacitive resistor represents a strict requirement on the control system, so that exact calibration is necessary and slight misalignment can occur.

Typically, containers made from flexible materials, such as, for example, plastic bags, are used as containers for the drinkable liquid, so that, as the drinkable liquid is removed, the total volume of the container also decreases.

### SUMMARY

The invention is based on the objective of improving the known devices for delivering drinkable liquid to the extent that, first, an economical and simultaneously sufficiently exact monitoring of the fill level of the container is possible for drinkable liquid. Furthermore, the monitoring should be as robust as possible, that is, misalignment and the recalibration necessary because of this misalignment should be prevented and errors in the measurements due to external effects should be reduced.

This objective is met by a device for delivering drinkable liquid according to the invention and also by a method for delivering drinkable liquid according to invention.

Advantageous constructions of the device and method are provided in the description and claims which follow.

The device according to the invention for delivering drinkable liquid thus comprises a pump, which can be connected to a container for drinkable liquid in such a way that the drinkable liquid can be delivered out of the container by means of the pump.

Typical drinkable liquid here includes, in particular, as already mentioned, milk, wherein the device according to the invention is also suitable for delivering any other drinkable liquid, in particular, also liquids with an essentially higher viscosity, such as, for example, syrup.

The fill level of the container for the drinkable liquid is monitored by a sensor, wherein, when the measurement signal falls below or exceeds a given limit of the sensor, the pumping process is stopped.

It is essential that the sensor is constructed as a pressure sensor. This pressure sensor is arranged in such a way that the pressure in the container for drinkable liquid can be measured by the pressure sensor.

In contrast to the known state of the art, the measurement is performed not by a capacitive resistor, but instead by a pressure measurement of the pressure in the container for drinkable liquid. For empty or nearly empty containers, the pressure in the container changes, so that the empty container is detected based on this pressure change and the pump process can be stopped.

Here, it is especially advantageous when the pump has a suction inlet and a suction line. The suction line is connected, on one side, to the suction inlet of the pump and, on the other side, to the container for the drinkable liquid. In normal operation, the drinkable liquid is suctioned out of the container by the pump through the suction line. If flexible containers are used, then the container is compressed in this way, so that the pressure in the container is approximately constant. In particular, it is advantageous to use a flexible container, which has only one outlet connected to the suction line. When liquid is delivered out of this container via the suction line, the container is thus compressed, because no air can penetrate into the container from the surroundings and replace the suctioned liquid. The total volume of the container thus decreases as the liquid is suctioned out.

When the container is empty, however, due to the suction process the pump generates a negative pressure, which is detected by the pressure sensor. This is a clear indication for an empty container, so that an empty container is clearly detected as a function of the measured pressure—that is, for the presence of a negative pressure relative to the surroundings—and the pump process can be stopped.

The pressure sensor can be arranged, in principle, at any position, at which there is a pressure connection to the container and thus a measurement of the pressure in the container is possible.

However, it is especially advantageous to arrange the pressure sensor on the suction line, so that the pressure in the suction line and thus also the pressure in the container can be measured via the pressure sensor.

In this way, an exchange of the container is simplified, because only the container has to be removed from the suction line and replaced by a new, full container, without having to arrange the pressure sensor again.

The suction line is advantageously constructed as a line with three openings. This line can be connected with a first opening to the container for drinkable liquid and with a second opening to the suction inlet of the pump. The pressure sensor is arranged on a third opening of the line.

For reducing the flow resistance, it is advantageous if there is a somewhat straight connection between the first opening and the second opening. Here, the drinkable liquid can be essentially straight, that is, it can reach from the container for drinkable liquid to the pump without large flow turbulence, so that the flow resistance is minimized.

In particular, it is advantageous to construct the line as a T-line: the connection to the third opening, at which the pressure sensor is arranged, is advantageously arranged approximately at a right angle to the straight connection between the first and second opening, so that the T-line approximately corresponds to the shape of a “T”.

The latter leads to another advantage that, due to the flow from the container to the pump, the drinkable liquid does not flow against the vacuum sensor with a high flow pressure, so that falsification of the measurement is prevented.

For a compact construction of the device according to the invention, it is advantageous to construct the suction line as a Y-line, i.e., as a line in the form of a “Y” with three openings, because then the pressure sensor can be arranged close to the other arms of the suction line. Advantageously, the pump and the pressure sensor are connected to adjacent arms and the container is connected to the third arm.

If the suction line is constructed as a T-line or Y-line, then drinkable liquid, which is not replaced by drinkable liquid flowing out of the container, can remain in the arm, on whose end the pressure sensor is arranged, according to the flow rate and dimensions of the line. Therefore, it is advantageous if this part of the T-line or Y-line, which connects the third opening to the connection between the first and the second opening, is as short as possible. Tests of the applicant have shown that a length of less than 20 cm, in particular, less than 10 cm, at best, in particular, less than 5 cm, is advantageous.

As described above, when the container is empty, the pump generates a negative pressure in the container and the suction line. The device is advantageously constructed in such a way that the pump process is stopped when the pressure at the pressure sensor falls below a given pressure limit.

Tests of the applicant have shown that the device is constructed advantageously in such a way that a pressure limit value in the range from −2.5 psi (approximately −0.172 bar) to −12.5 psi (approximately −0.862 bar) can be set selectively.

The pressure values are specified as negative numbers in order to make it clear that these values involve negative pressures relative to the prevailing pressure in the surroundings. If the ambient pressure equals, for example, 14.5 psi, approximately 1 bar), then there is a negative pressure of at least −2.5 psi for pressure values less than or equal to 12 psi (approximately 0.826 bar) and of at least −12.5 psi for pressure values less than or equal to 2 psi (approximately 0.138 bar).

In this case, the user can thus set a pressure limit, which is adapted to contingent specifications, such as, for example, special constructions of the container for the drinkable liquid or to the viscosity of the drinkable liquid, between the given limits.

Studies of the applicant, however, have shown that for typical fields of application, fixed limits can be set. The device is advantageously constructed in such a way that a pressure limit is set rigidly in the range from −2.5 psi to −12.5 psi. In particular, tests of the applicant have shown that a given pressure limit of approximately −5 psi (approximately −0.345 bar) is meaningful. Here, by the negative sign it is also specified that the specified pressure values involve a negative pressure relative to the pressure prevailing in the surroundings.

Thus, in this advantageous construction, no input of the pressure limit by the user is necessary; the device shuts down the pump process automatically for a negative pressure less than −5 psi.

The selection of the pressure limit at −5 psi has the advantage that, in particular, for the delivery of milk, the pump process is stopped by this selection of the pressure limit when the milk bag is indeed empty or nearly empty, but the milk lines of the device, in particular, the T-line described above, are still filled with the drinkable liquid, such as, for example, milk. Thus, after an exchange of the container, no air bubbles are produced in the lines, so that de-airing or “priming” is eliminated.

Thus, as described above, not the absolute pressure in the container, but instead the differential pressure relative to the surroundings is measured.

Instead of a differential pressure, however, it also lies in the scope of the invention to measure the absolute pressure in the container and to specify, accordingly absolute pressure limits as the limits. Because the normal pressure equals approximately 14.5 psi (approximately 1 bar), the setting of absolute limits between 12 psi (approximately 0.826 bar) and 2 psi (approximately 0.138 bar) is meaningful, in particular, the setting of 9.5 psi (approximately 0.655 bar).

Coffee machines represent a typical field of application for the device according to the invention, in particular, automatic coffee machines for large quantities, like those used, for example, in restaurants.

Such a coffee machine comprises a brewing unit for producing coffee. The brewing unit can be constructed such that completely brewed coffee is kept warm and dispensed when needed or that, for example, fresh coffee beans are ground and brewed, when needed. It is essential that the coffee machine comprises a device for delivering drinkable liquid, so that, for example, milk can be fed to the coffee, optionally in the form of milk froth after passing through a milk frother.

Such a coffee machine is advantageously constructed in such a way that the device is constructed for delivering drinkable liquid from the device according to the invention, that is, in particular, the fill level of the container for drinkable liquid is monitored by a pressure sensor.

Such a coffee machine typically comprises a control unit, which requests, when needed, milk from the device for delivering drinkable liquid. Now, if the container empties completely during the delivering of milk requested by the control unit, then, as previously described, a negative pressure is created, which is detected by the pressure sensor. Advantageously, the pressure sensor is connected to the control unit of the coffee machine, so that, first, the brewing process can be stopped by the control unit and, second, the control unit is also connected to the pump of the device for delivering drinkable liquid, so that the pump process is also stopped.

Advantageously, the control unit is constructed in such a way that, when the pressure drops below the given pressure threshold in the container, that is, when the container is empty, an optical and/or acoustic signal is output, so that the user can replace the container.

Above, the use of the device according to the invention for delivering milk in a coffee machine was described. However, the use of the device according to the invention is also conceivable for delivering any other foodstuff, in particular, also syrup.

It also lies in the scope of the invention to provide a coffee machine with several containers for drinkable liquid, from which drinkable liquid can be requested selectively by the control unit of the coffee machine.

Here, it is conceivable that a pump is connected to several containers via a valve system, so that the valves are set by the control unit in such a way that the pump delivers the desired foodstuff from the desired container. This produces the advantage that only one vacuum sensor is needed in the suction line directly in front of the pump, in order to monitor the fill level of the container, from which the drinkable liquid is currently being taken.

It is also conceivable to provide for each container a separate vacuum sensor or for each container a separate milk pump and a separate vacuum sensor.

### BRIEF DESCRIPTION OF THE SEVERAL VIEWS OF THE DRAWINGS

Other advantageous constructions will be described below using an embodiment. Shown are:

FIG. 1 is a view of a coffee machine with a device according to the invention for delivering drinkable liquid.

### DETAILED DESCRIPTION OF THE PREFERRED EMBODIMENTS

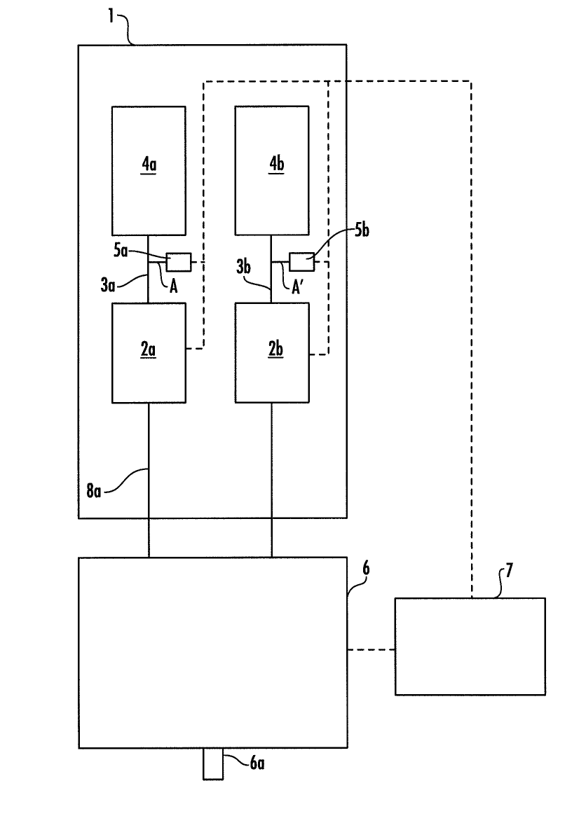

The coffee machine shown in FIG. 1 comprises a device for delivering drinkable liquid 1, which comprises two pumps 2a and 2b. Each pump is connected by a suction line 3a, 3b constructed as a T-line to a container for drinkable liquid 4a, 4b.

The container 4a is a milk bag, which contains whole milk, while the container 4b is a milk bag, which contains reduced-fat milk.

The suction lines 3a and 3b are each connected with the first opening to the containers 4a and 4b and with the second openings to the milk pumps 2a and 2b. Here, the suction lines 3a and 3b are constructed in such a way that the connection between the first and the second openings is straight, so that the smallest possible flow resistance exists when milk flows from the containers to the milk pumps.

At the third opening of the suction lines 3a and 3b there are pressure sensors 5a and 5b, wherein the part of the suction line that connects the third opening to the connection between the first and the second opening (designated as part A and A′ in FIG. 1) has a length of less than 1 cm, so that, in this part, only a negligible amount of milk remains.

Furthermore, the parts A and A′ are at a right angle to the straight connection between the first and second opening of the suction lines 3a and 3b, so that, due to the flow of liquid, only a negligible flow pressure is created on the pressure sensors 5a and 5b and thus does not falsify the pressure measurement.

The coffee machine shown in FIG. 1 further comprises a brewing unit 6 and also a control unit 7.

The control unit 7 is connected by control lines (illustrated as dashed lines) to the brewing unit 6 and also to the device for delivering drinkable liquid 1 (each to the pumps 2a and 2b and also the pressure sensors 5a and 5b) and in it are stored several programs for different beverages, such as, for example, cappuccino, café au lait, etc.

If the user selects, for example, café au lait (with whole milk) on the control unit 7 via an input unit (not shown), then the control unit 7 controls the brewing unit 6 in such a way that on the outlet 6a, initially a predetermined quantity of coffee is dispensed, which corresponds to a cup that is approximately ¾ full. Then the control unit 7 controls the pump 2a of the device for delivering drinkable liquid 1 in such a way that whole milk is taken from the container 4a via the suction line 3a and is dispensed to the brewing unit 6 via a pressure line 8a. In the brewing unit 6 there is a (not shown) connection to the outlet 6a, so that the whole like is also dispensed into the cup via the outlet 6a.

During the pumping process, if the container 4a is completely emptied, then a negative pressure is created in the container 4a and in the suction line 3a and thus also at the pressure sensor 5a.

The pressure sensors 5a and 5b are also connected to the control unit 7 and the control unit 7 is set to stop the pumping process for a negative pressure of at least −5 psi.

In the present example, the control unit 7 thus stops the pumping process by stopping the pump 2a and outputs, via a (not-shown) display unit, a signal that the container 4a for whole milk must be replaced.

As soon as the container for whole milk is replaced, the user confirms this with the input unit for the control unit 7, so that the pump process can be continued and the preparation of the café au lait is completed.

The monitoring of the fill level of the container 4b is performed analogously.

For connecting the suction lines 3a and 3b to the containers 4a and 4b it is essential that these are pressure-tight. If the device is constructed, for example, for the use of containers with screw closures, then the suction lines 3a and 3b have corresponding counter pieces for screwing onto the screw closures of the containers 4a and 4b, so that by the screwing process, a pressure-tight connection can be created.

If the device according to the invention is used for delivering liquids with higher viscosity, such as, for example, syrup, it is essential that, in particular, the suction lines 3a and 3b have a sufficient diameter. Here, the connection should have a diameter of at least ⅜″ (approximately 0.9525 cm) continuously from the first to the second opening of the suction lines. The connection to the third opening, at which the pressure sensors 5a and 5b are arranged, can have a smaller diameter, which should equal at least ¼″ (approximately 0.635 cm).

Above, the embodiment shown in FIG. 1 has been described in such a way that the containers 4a and 4b contain different types of milk. It is also within the scope of the invention, however, to use several containers with the same drinkable liquid, for example, such that both the container 4a and also the container 4b contain whole milk.

The controller 7 is constructed advantageously in such a way that first the container 4a is emptied, when needed, by the pump 2a and as soon as an empty container 4a is detected by the pressure sensor 5a, the controller 7a switches to the pump 2b, so that, without interrupting the preparation process of the beverage, the system switches from the (now empty) container 4a to the (full) container 4b.

Simultaneously, the control unit 7 outputs an acoustic and/or optical signal that the container 4a is empty, so that during the operation of the coffee machine, the container 4a can be replaced, because during the replacement process, if needed, milk is delivered from the container 4b.

In an analogous way, when the container 4b is empty, the system automatically switches to the container 4a via the control unit 7 and a corresponding optical and/or acoustic signal is output that the container 4b is empty.

1. Device (1) for delivering drinkable liquid, comprising:
at least one pump (2a, 2b), which is connectable to at least one container (4a, 4b) for the drinkable liquid, such that the drinkable liquid can be delivered from the container by the pump;
at least one sensor (5a, 5b) for measuring a fill level of the container for drinkable liquid;
a controller that stops the pumping process when a measurement signal from the at least one sensor falls below or exceeds a limit; and
the sensor (5a, 5b) comprises a pressure sensor arranged to measure a pressure in the container (4a, 4b) for the drinkable liquid.

2. Device according to claim 1, wherein
the pump (2a, 2b) has a suction inlet and a suction line (3a, 3b), and on one side, the suction line is connected to the suction inlet and on the other side, the suction line is connectable to the container (4a, 4b) for drinkable liquid.

3. Device according to claim 2, wherein
the pressure sensor (5a, 5b) is arranged on the suction line such that the pressure in the suction line (3a, 3b) can be measured by the pressure sensor.

4. Device according to claim 3, wherein
the suction line (3a, 3b) is constructed as a line with three openings, wherein a first one of the openings is connectable to the container (4a, 4b) for drinkable liquid, a second one of the openings is connected to the suction inlet of the pump (2a, 2b), and the pressure sensor (5a, 5b) is arranged on a third one of the openings of the line.

5. Device according to claim 4, wherein
the suction line is a T-line and is constructed such that, between the first and second opening, there is an approximately straight connection, and a connection to the third opening is approximately at a right angle to the straight connection between the first and second openings.

6. Device according to claim 4, wherein
the suction line is a T-line or Y-line and the part (A, A′) of the suction line which connects the third opening to the connection between the first and second opening, has a length of less than 20 cm.

7. Device according to claim 1, wherein
the device is constructed such that the pumping process is stopped when the pressure sensor measures a negative pressure below a given pressure limit.

8. Device according to claim 7, wherein
the pressure limit can be selectively set in a range from −2.5 psi to −12.5 psi.

9. Device according to claim 7, wherein
the pressure limit is set at approximately −5 psi.

10. Coffee machine, comprising:
a brewing unit (6) for generating coffee and a device (1) for delivering drinkable liquid;
the device for delivering drinkable liquid comprises the following elements:
at least one pump (2a, 2b) which is connectable to at least one container (4a, 4b) for drinkable liquid, such that the drinkable liquid can be delivered from the container by the pump;
at least one sensor (5a, 5b) for measuring a fill level of the container for drinkable liquid;
the at least one sensor is adapted to stop the pumping process as a function of a measurement signal from the at least one sensor when the measurement signal falls below or exceeds a set limit; and
the sensor (5a, 5b) comprises a pressure sensor arranged to measure a pressure in the container (4a, 4b) for the drinkable liquid; and
the coffee machine is constructed such that the coffee created by the brewing unit (6) and the drinkable liquid delivered by the pump are dispensed at a common outlet location (6a) or at adjacent outlet locations.

11. Coffee machine according to claim 10, wherein
the coffee machine comprises a control unit (7), which is connected to the pressure sensor (5a, 5b) and the pump (2a, 2b) and which is constructed in such a way that the control unit stops the pumping process as a function of the measurement signal from the pressure sensor when the pressure falls below a given pressure in the container (4a, 4b) for drinkable liquid, and the control unit (7) is also connected to the brewing unit (6) and is constructed such that both the pumping process and also the brewing process are stopped when the pressure falls below a given pressure in the container for drinkable liquid.

12. Coffee machine according to claim 11, wherein
the control unit (7) outputs an optical and/or acoustic signal when the pressure falls below the given pressure in the container (4a, 4b) for drinkable liquid.

13. Method for delivering drinkable liquid, comprising the following steps:
delivering drinkable liquid from a container (4a, 4b) via a pump (2a, 2b) and monitoring a fill level of the container via a sensor (5a, 5b),
monitoring the fill level of the container by measuring a pressure in the container using a pressure sensor, and
stopping the pumping process when the pressure falls below a given pressure as a function of a measurement signal from the pressure sensor.

14. Method according to claim 13, wherein
the pumping process is stopped when a negative pressure in the container (4a, 4b) equals at least −2.5 psi.

15. Method according to claim 13, wherein
the pumping process is stopped when a negative pressure in the container (4a, 4b) equals at least −5 psi.

16. Device according to claim 4, wherein
the suction line (3a, 3b) is constructed as a T-line or as a Y-line
